(19) United States
(12) Patent Application Publication
(10) Pub. No.: US 2008/0077519 A1
(43) Pub. Date: Mar. 27, 2008

(54) System, Method, and Computer Program for Providing Guaranteed Retirement Income Protection Products

(75) Inventors: Dana Marie Pedersen, Avon, CT (US); John Francis Shary, Westwood, MA (US); Zafar Rashid, Avon, CT (US); Kathleen Ann McGah, Weatogue, CT (US); Paula Kay Kern, Simsbury, CT (US); Mitchell L. Katcher, Stamford, CT (US)

Correspondence Address: FISH & RICHARDSON P.C., P.O. BOX 1022, MINNEAPOLIS, MN, 55440-1022, US

(73) Assignee: Phoenix Companies, Inc., The, Hartford, CT (US)

(21) Appl. No.: 11/846,387

(22) Filed: Aug. 28, 2007

Related U.S. Application Data
(60) Provisional application No. 60/840,421, filed on Aug. 28, 2006.

(51) Int. Cl. G06Q 40/00; G06F 17/10; G06F 17/40

(52) U.S. Cl. 705/36 R; 705/39

(57) ABSTRACT

A system and method is disclosed for providing an investor with liquidity in a first phase, and selectively providing a guaranteed minimum income amount in a second phase. The first phase terminates upon a date certain. The second phase begins after the first phase terminates. However, certain factors can affect whether the guaranteed minimum income is paid in the second phase. For instance, the guaranteed minimum income amount is not paid until and unless the designated liquid assets have been depleted. Moreover, although liquidity is provided in the first phase, certain parameters may be imposed on the investment of the liquid assets (for example, the risk profile of the liquid assets).

### CLAIM OF PRIORITY

This application claims priority under 35 U.S.C. §119(e) to U.S. Provisional Patent Application Ser. No. 60/840,421, filed on Aug. 28, 2006, which is incorporated by reference.

### TECHNICAL FIELD

This disclosure relates to a financial product that provides liquidity in a first phase, and selectively guarantees retirement income to a Covered Person in a second phase. This disclosure also relates to systems, methods, and computer programs for providing guaranteed retirement income protection.

### BACKGROUND

Presently, many retirees are facing the realistic possibility of outliving their retirement savings. This problem (referred to in retirement planning as “superannuation”) is particularly burdensome where retirees are dependent upon plans which they contribute to (e.g., 401(k) plans), as opposed to defined benefit plans (e.g., pensions), for retirement income. To avoid the risk of outliving retirement savings, many retirees drastically reduce their spending, and hence, their standards of living, to conserve their retirement savings.

One investment option to guard against superannuation is an immediate payout annuity. In order to obtain an immediate payout annuity, an individual liquidates or “rolls over” accumulated assets to make a lump sum annuity purchase. Generally speaking, annuity payments are fixed periodic payments and typically commence within one year from the date of purchase of the annuity. This option, however, has several disadvantages. First, many individuals are unwilling to forego the liquidity and control of large sums of assets by investing them all into a single annuity. Indeed, by rolling assets into a single fixed immediate annuity, the ability to invest these assets in financial markets is eliminated, thereby precluding potential gains that could result had the assets been invested in such markets. Moreover, because annuity pricing is a function of anticipated returns, immediate annuity purchasers are at the mercy of market conditions at the time of purchase. Finally, after investing a large sum of assets into a single fixed immediate annuity, a retiree may die prematurely and forfeit any and all lifetime income payments.

Other investment strategies to avoid superannuation include structured withdrawals (e.g., from a 401(k) or savings account) that are targeted to match a retiree's life expectancy and periodic fixed-dollar withdrawals that do not detract from principal. However, it is projected that structured withdrawals will fail approximately 50% of the time for longer retirements, depending on assumed investment returns and expenses. Although periodic fixed-dollar withdrawals tend to fail less frequently than structured withdrawals, failures still occur. Moreover, due to interest rate and market variance, for example, it is often difficult for the retiree to properly know how much he or she can spend in the future.

Further complicating the problem of outliving retirement savings, retirees are living longer than ever. Unfortunately, many individuals still assume that they will not reach older ages in retirement, and therefore fail to properly plan for retirement income at advanced ages. However, recent longevity statistics show that a large number of retirees will reach ages of 90 or older. For example, a 65-year-old woman has a 40% chance of living to age 90, a 20% chance of living to age 95, and a 5% chance of living to age 100. For married couples where both spouses are 65 years old, at least one of the spouses has a 57% chance of living to age 90, a 28% chance of living to age 95, and a 7% chance of living to age 100. With future advances in medical science, life expectancies will likely increase even more. Thus, there is an increasing need to provide retirement income at advanced retirement ages.

Longevity insurance has been proposed as a potential solution for providing retirement income at advanced ages. Longevity insurance is typically provided in the form of an advanced-life delayed annuity that is adjusted for consumer price inflation. With this approach, the annuity is acquired at a young age and small premiums are paid over a long period of time. Upon reaching a predefined advanced age (e.g., age 80, 85, 90), inflation-adjusted income is provided. However, this approach has several shortcomings, including its failure to insure against the early exhaustion of retirement assets.

### SUMMARY

One aspect of the invention is a financial investment product for providing an investor with liquidity in a first phase, and selectively providing a guaranteed minimum income amount in a second phase. The first phase terminates upon a date certain. The second phase begins after the first phase terminates. However, certain factors can affect whether the guaranteed minimum income is paid in the second phase. For instance, the guaranteed minimum income amount is not paid until and unless the designated liquid assets have been depleted or meet a certain minimum amount. Moreover, although liquidity is provided in the first phase, certain parameters may be imposed on the investment and/or withdrawal of the liquid assets.

Another aspect of the invention relates to software, as well as one or more computers programmed with that software, for providing and administering a financial investment product.

The details of one or more implementations are set forth in the accompanying drawings and the description below. Other features and advantages will be apparent to one of ordinary skill in the art from the description and drawings, and from the claims.

### BRIEF DESCRIPTION OF DRAWINGS

FIG. 1 is an exemplary certificate.

FIG. 2 is a flowchart illustrating a method of purchasing a guarantee.

FIG. 3 is a graph illustrating an exemplary guarantee.

FIG. 4A is a flowchart illustrating methods of increasing the Retirement Income Base.

FIG. 4B is a flowchart illustrating methods of decreasing the Retirement Income Base.

FIG. 5 is a flowchart illustrating a method for updating the Policy Issuer's records due to sponsor account activity.

FIG. 6 is a flowchart illustrating methods relating to the Annual Retirement Income Amount.

FIG. 7 is an overview of a data exchange architecture.

FIG. 8 is an overview of Policy Issuer data exchange.

### DETAILED DESCRIPTION

The following description relates to implementations of systems, methods, and computer program products for providing a financial product that maintains liquidity in a first phase, and selectively provides a guaranteed minimum lifetime income amount in a second phase. The following description is provided in conjunction with the figures, which are merely illustrative of some implementations.

The financial product of some of the implementations is an insurance policy known as Guaranteed Retirement Income Solutions (referred to herein as a “GRIS”) and is implemented in cooperation with an investment advisor, broker-dealer, bank, mutual fund family or any other financial institution. For convenience, the members of this class (individually or collectively) will be referred to as a “sponsor.” Individuals or entities who maintain accounts with these sponsors will be referred to as “clients.” In some examples, the GRIS may be provided by a third party insurance Policy Issuer for the sponsor's clients who intend to designate investments in their sponsor account (e.g., an existing account or a new account) as the basis for a withdrawal program to provide retirement income payments or other long-term purposes. For example, a client may hold an account with Brokerage A. Brokerage A, as the sponsor, may offer the client the GRIS provided by a Policy Issuer. Alternatively, an investment advisor (e.g., a private account manager) may, as the sponsor, offer the client the GRIS available from the Policy Issuer.

The Policy Issuer may also offer the GRIS directly to the client. In each of these examples, the assets in the client's account with the sponsor remain the property of the client, not the Policy Issuer.

In various implementations, the GRIS provides income protection relating to the investments in a client's sponsor account after the client's sponsor account is reduced to $0 (or some other predetermined minimum amount), separate from the client's sponsor account. Preferably, the GRIS includes a guarantee that ensures predictable lifetime income payments regardless of the actual performance or value of the assets in the client's sponsor account, by providing continuing income payments if the client's sponsor account investments are reduced to $0 (or in some other implementations, to some certain minimum amount which may or may not be transferred to the Policy Issuer) by allowable withdrawals and/or poor market performance. In some implementations, the GRIS itself has no cash value. Rather, the client owns the assets in its sponsor account.

The guarantee feature of the GRIS preferably takes the form of a synthetic annuity or funding agreement, insurance policy, or contract that provides continuing lifetime income payments if the client's investments in its sponsor account are depleted by allowable withdrawals and/or poor market performance. Such policy or contract may be funded by a Policy Issuer in its general account and/or separate account. The policy or contract is synthetic since the Policy Issuer does not have custody of the client's sponsor account. Subject to certain conditions, continuing lifetime income payments will begin if the client's sponsor account is depleted while the client (or, in some examples, the client and its spouse) are still living. Preferably, the lifetime income payments cannot begin until a pre-established date (e.g., the Retirement Income Date, as discussed below).

Various implementations of the GRIS are characterized by two phases: (1) an accumulation phase; and (2) a retirement phase. The first phase (accumulation phase) of the GRIS begins when the client purchases the GRIS, either from the sponsor or otherwise. The client can purchase the GRIS when it opens its sponsor investment account or at any time thereafter. During the accumulation phase, the assets in the client's sponsor account may remain invested in financial markets, may increase or decrease in value based on market performance, and the client may take withdrawals from the sponsor account but it may reduce the client's future income benefit. The accumulation phase ends on a pre-established date (e.g., the Retirement Income Date, as discussed below).

The second phase (“retirement phase”) of the GRIS preferably begins when the first phase ends (e.g., the Retirement Income Date). The retirement phase may comprise two sub-phases. A first sub-phase (“withdrawal phase”) will commence if a client has assets remaining in his sponsor account beyond the Retirement Income Date. As such, the client may begin taking certain withdrawals from his or her sponsor account. As long as the withdrawals meet certain requirements discussed in more detail herein, the client's eligibility to receive lifetime income payments is unaffected.

The first sub-phase will end when the client has no assets remaining in the client's sponsor account. At such time, a second sub-phase (“guarantee phase”) will commence. At this time, the client may be eligible to begin receiving lifetime income payments from the Policy Issuer. It is possible for a client to reach the guarantee phase of the GRIS without first passing through the withdrawal phase if due to poor market performance, for example, the client's account value is reduced to $0 prior to the Retirement Income Date.

The GRIS Certificate

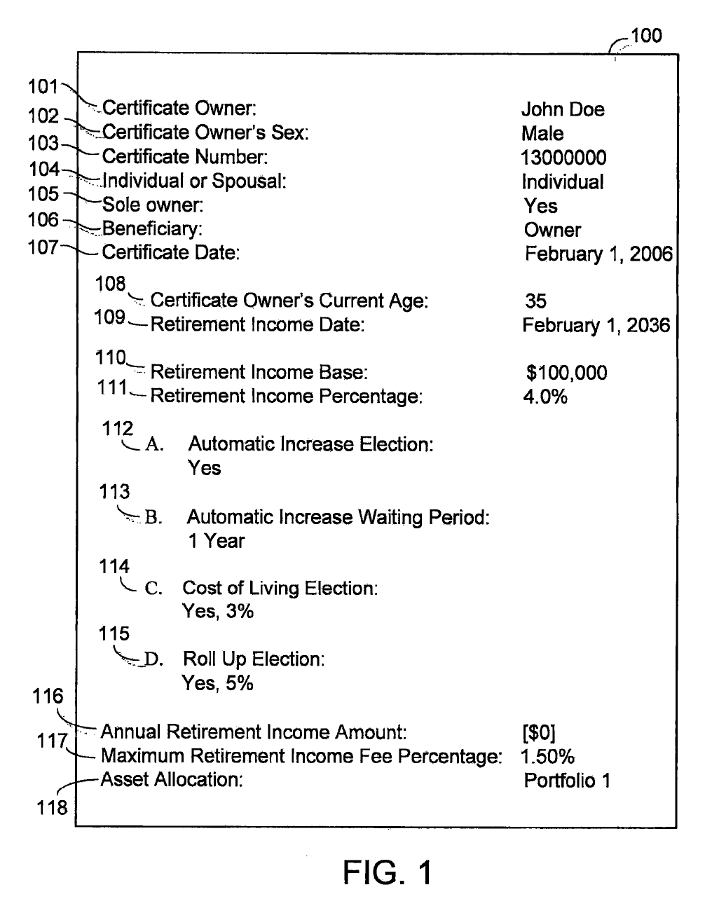

When the client purchases a GRIS, the client is preferably issued a GRIS certificate. In some implementations, the GRIS will be offered as a group contract and certificate. The group policy or contract is issued to the sponsor, while the certificate is issued to the client. In other implementations, the GRIS will be offered as an individual policy or contract to the client. The GRIS certificate preferably describes certain obligations and rights of the client, the sponsor, and/or the Policy Issuer. While the certificate can take many forms, it preferably indicates at least certain information about the client and certain choices made by the client. The features of an exemplary GRIS certificate are discussed below with reference to a simplified exemplary certificate as illustrated in FIG. 1. The GRIS certificate preferably specifies a Certificate Date 107. The Certificate Date is preferably the date that the GRIS policy is purchased. While it is discussed in greater detail herein, the Certificate Date is used in various aspects and operations of the described examples and implementations thereof. The certificate 100 indicates the certificate owner's name 101 (who in this example is the same person as the client and Covered Person 106), the certificate owner's sex 102, and a certificate number 103 for record keeping purposes. Moreover, the certificate indicates whether the client chose the individual guarantee or the spousal guarantee 104. In this example, the client chose the individual guarantee. An individual guarantee applies to individual Covered Persons and, under certain circumstances, guarantees income until the death of the individual Covered Person, or where there are multiple Covered Persons, the death of the first Covered Person. The spousal guarantee applies to a married couple as beneficiaries and, under certain circumstances, guarantees income until the death of the last living spouse. Moreover, the certificate 100 specifies whether the client is the sole owner 105 of the certificate. In other examples, the certificate may be jointly owned. Depending upon the provisions of the certificate 100, a client may choose someone other than himself to receive the benefits of the guarantee and/or own the certificate.

The certificate 100 also preferably indicates the Covered Person's birth date and/or current age 108, and a Retirement Income Date 109. In this example, the Retirement Income Date is 30 years from the Certificate Date 107 and arrives when the client is 65 years old. The Retirement Income Date has significance for at least three purposes. First, it represents the date on which the annual retirement income amount is first calculated (i.e., the yearly guaranteed income paid in the guarantee phase). Second, it represents the date when person who is the Covered Person of the GRIS is first eligible to be paid the Annual Retirement Income Amount (“ARIA”), if certain conditions are met. Third, it represents the first date when certain allowable withdrawals from the sponsor account may be made, if funds remain in the sponsor account (i.e., if the account value does not equal 0). The Retirement Income Date 109, depending on the implementation, can be determined by, e.g., setting a fixed age (e.g., 65), a certain time period from the Certificate Date (e.g., 30 years as in this example), or can be a date chosen by the client, sponsor, and/or Policy Issuer.

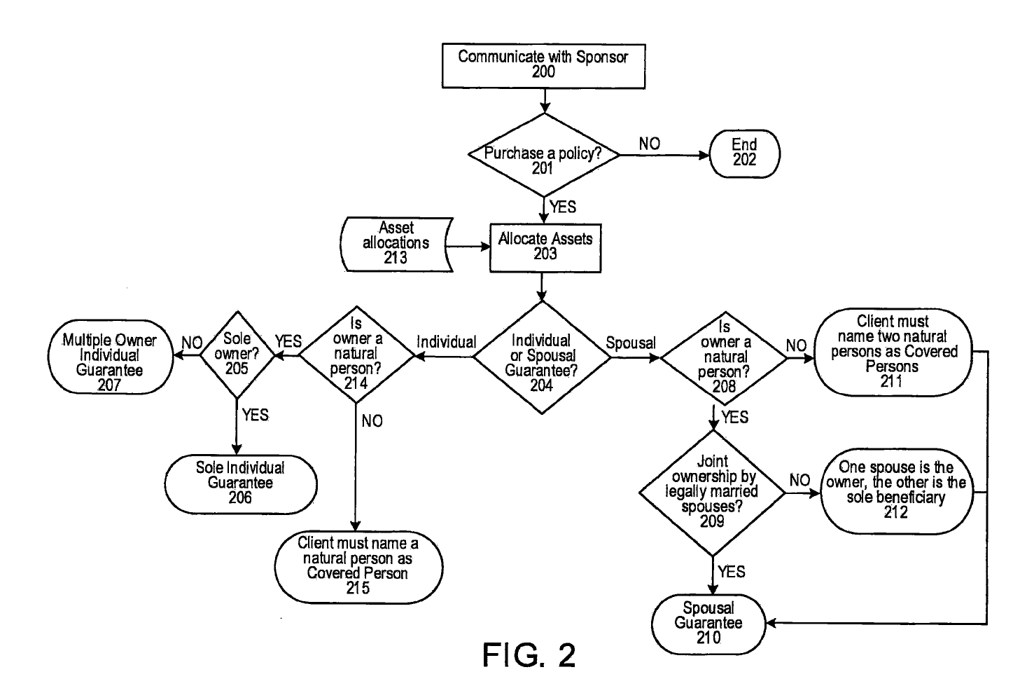

The certificate 100 further specifies the Retirement Income Base (“RIB”) 110 on the Certificate Date 107. When a client purchases a policy, a Retirement Income Base is preferably established for the client. The amount of the Retirement Income Base is preferably derived from the amount that the client invests when it opens its sponsor account and contemporaneously purchases a policy, or the account value of the client's designated sponsor account if it is already in existence when he purchases a policy. As will be discussed herein, the Retirement Income Base 110 can both increase and decrease depending on various factors. As specified on the certificate, it represents the value of sponsor account assets allocated toward the GRIS (e.g., step 203 of FIG. 2) on the Certificate Date. Sponsor account assets that are allocated toward the GRIS are referred to in the examples and implementations thereof as “Covered Assets.” Thus, on the Certificate Date 107, the Retirement Income Base 110 is equal to the amount of Covered Assets.

The certificate 100 also specifies a Retirement Income Percentage (“RIP”) 111. In this example, the RIP is 4.0%. The Retirement Income Percentage 111 represents the percentage of the Retirement Income Base 110 the client will receive on annual basis should lifetime payments ensue under the guarantee aspect of the GRIS. In other words, the RIP multiplied by the RIB equals the ARIA and can be represented by the following formula:
ARIA=RIP*RIB.

In some implementations, this calculation only applies on the date that the ARIA is re-calculated (e.g., January 1st of each calendar year, the Certificate Anniversary of each Certificate Year, 65th birthday of oldest Covered Person or any other agreed upon date). If the Retirement Income Date falls on a re-calculation date, then the ARIA will equal RIP*RIB on the Retirement Income Date. However, if the Retirement Income Date does not fall on a re-calculation date, then the ARIA will be pro-rated based on the number of days until the next re-calculation date.

The RIP, depending on the implementation, can be determined by, e.g., a sponsor and/or Policy Issuer choice (e.g., the sponsor may limit or select the RIP and/or may make an actuarial determination to offer a client a particular RIP) or the client may choose a percentage (e.g., a client may choose different RIPs each having an associated GRIS fee). The Policy Issuer or sponsor may reserve the right to alter the RIP on a yearly basis. Also, in some implementations, the RIP may automatically increase if the client reaches a certain age and has not taken any withdrawals and has not received any guaranteed income. For example, if the client surpasses seventy years of age, the RIP may increase by a percentage. If the client reaches eighty years of age, the RIP may increase yet again.

Note, however, that the ARIA payments actually made by the Policy Issuer in the guarantee phase are equal to the Retirement Income Percentage multiplied by the Retirement Income Base on the date that the guarantee phase commences, not on the Certificate Date 107. When and if the guarantee phase begins, the Retirement Income Base 110 can be more, less, or equal to what it was on the Certificate Date 107. The Retirement Income Percentage multiplied by the Retirement Income Base also represents the maximum amount the client can withdraw from the sponsor account per annum after the Retirement Income Date 109 without penalty. This can be represented by the following equation:
W_{MAX}=RIP*RIB

It is worth noting that the certificate 100 preferably does not specify the ARIA 116. While given the parameters of this exemplary certificate 100, one could expect the ARIA 116 to be $4,000 ($100,000*4%), the ARIA 116 is preferably not determined and/or communicated to the client until (or near) the Retirement Income Date 109. This is because, among other reasons, the Retirement Income Base 110 can vary and payment of the ARIA 116 is contingent upon several factors, e.g., whether the account value is reduced to $0 and whether the Retirement Income Date 109 has passed.

The Policy Issuer and/or sponsor preferably receives payment (e.g., an insurance fee) for providing the guarantee. The insurance fee covers the costs of the Policy Issuer (1) to purchase hedging instruments to fund the guarantee, (2) to administer the GRIS, and (3) other expenses in addition to providing profits to the Policy Issuer. The Policy Issuer or sponsor may receive the GRIS fee directly, and divide the fee as determined by the Policy Issuer and sponsor. In some examples, either the sponsor or Policy Issuer receives the entire fee. Accordingly, the certificate 100 indicates the Maximum Retirement Income Fee Percentage (“MRIFP”) 117. In this example a maximum MRIFP of 1.5% of the Retirement Income Base, per annum, is deducted from the sponsor account and paid to the Policy Issuer for as long as the client's sponsor account value is greater than 0. The preferred formula for calculating the total maximum fee on a per annum basis is:
GRIS fee=MRIFP*RIB

Note that, depending on the implementation, the current Retirement Income Fee Percentage (RIFP) may, at a given point in time, be less than the MRIFP. In most implementations, the RIFP may never be greater than the MRIFP. For illustration, discussion of some of the implementations assume that the MRIFP=RIFP.

Of note, in some implementations (1) fees are automatically deducted and (2) fee deductions do not decrease the Retirement Income Base for purposes of calculating the Annual Retirement Income Amount. Fees can be paid to the Policy Issuer on, e.g., a daily, weekly, monthly, and/or yearly basis. Of course, since the MRIFP is declared in this certificate 100 on a yearly basis, if the fee is paid on a monthly basis, for example, then the monthly installment would be one-twelfth of the MRIFP, or 0.125%. In some implementations, fee deductions may be deducted from another designated account. Fees are discussed in more detail in the section entitled “GRIS Fees.”

It is also preferred that the certificate 100 specify an asset allocation 118. The asset allocation 118 is a set of pre-approved investment options and/or models, which may include fund of funds, balanced and other measurable risk models. Because the Policy Issuer is insuring against the depletion of the Covered Assets after the Retirement Income Date 109 (e.g., due to allowable withdrawals and/poor market performance), it has an interest in the allocated assets being invested in an approved manner. In effect, the Policy Issuer is acting as a guarantor, and thus may approve of certain asset allocations and disapprove of others. Since the Policy Issuer is guaranteeing (in qualified instances) against the depletion of investment assets, it would prefer that the asset allocations are generally designed to provide consistent returns. Since asset allocations may vary, the MRIFP may vary depending upon the asset allocation chosen. The certificate 100 may specify which asset allocation the client is, and should remain, invested in. It is preferred that the client and sponsor agree upon an appropriate asset allocation strategy. Note that in some implementations, a client may invest his assets in more than one asset allocation. It is possible that the client or sponsor may change the approved asset allocation with permission of the Policy Issuer. It is also possible that, due to poor market performance in certain sectors, the Policy Issuer and/or sponsor can require the client to change his asset allocation or face a reduction (or elimination) in guaranteed benefits.

Also, it is preferred that the certificate 100 specify whether the client has elected numerous optional features of the guarantee. A client may later change these options, though in some implementations, the change may not take effect until either the following January 1 or the following anniversary of the Certificate Date 107.

The client may elect the Automatic Increase Option 112. This feature automatically increases the Retirement Income Base 110 to equal the client's sponsor account value if latter exceeds the former. For example, favorable market performance can cause the client's account value to increase even if no deposits were made. The Automatic Increase preferably can occur on each anniversary of the Certificate Date 107 (in this example, Feb. 1, 2007, Feb. 1, 2008, Feb. 1, 2009, and so forth). The certificate 100 also specifies a waiting period for the Automatic Increase 113. In this case, the client must wait one year from the Certificate Date 107 before he is eligible for an Automatic Increase. Preferably, opting for this feature requires the client to pay an increased MRIFP.

Also, the certificate 100 indicates whether the client has opted for the Cost of Living election 114. If a client elects this option (as was done in this example), the client's Annual Retirement Income Amount increases yearly based on cost of living increases. Preferably, opting for this feature requires the client to pay an increased MRIFP.

The last option in this example is the Roll Up option 115. This feature rewards clients who do not withdraw assets from their sponsor accounts. For each year after the Certificate Date 107 that the client makes no withdrawals, he is eligible to receive, from the Policy Issuer, an increase in his Retirement Income Base. Preferably, opting for this feature requires the client to pay an increased MRIFP. These features are discussed in greater detail herein.

Some example types of GRIS policies include the following:

| Type | Example Features |
|---|---|
| Individual Guarantee, | 1. Individual GRIS fee |
| Nonqualified | 2. Single owner, though some |
| | implementations may allow multiple |
| | owners |
| | 3. One Covered Person, though some |
| | implementations may allow multiple |
| | Covered Persons |
| | 4. Terminates at the death of the (first) |
| | Covered Person |
| | 5. No death benefit (even if owner is a |
| | married person) |
| Individual Guarantee, | 1. Individual GRIS fee |
| Qualified (IRA) | 2. Single owner; owned by a trust for the |
| | benefit of an individual person |
| | 3. No spousal continuation |
| | 4. One Covered Person |
| | 5. Terminates at the death of the Covered |
| | Person |
| | 6. No death benefit (even if owner is a |
| | married person) |
| Spousal Guarantee, | 1. Spousal GRIS fee |
| Nonqualified | 2. Owned by legally married spouses (e.g., |
| | as defined by federal law) |
| | 3. Two Covered Persons (i.e., the spouses) |
| | 4. Terminates at death of the second |
| | spouse to die |
| Spousal Guarantee, | 1. Spousal GRIS fee |
| Qualified (IRA) | 2. Single owner. Owned by a trust for the |
| | benefit of an individual person (one |
| | spouse) AND the other spouse is listed as |
| | sole beneficiary of a death benefit (may be |
| | required for spousal continuation purposes) |
| | 3. The initiation documentation will, in |
| | some implementations, identify the two |
| | Covered Persons as the two spouses, but |
| | identified as: one being associated with the |
| | single owner (trust for benefit of one |
| | spouse) and the other spouse being the sole |
| | beneficiary of a death benefit |
| | 4. In some implementations, the spouses |
| | must have birth dates less than 5 years |
| | apart from each other (e.g., to |
| | accommodate the Required Minimum |
| | Distributions (“RMD”) issue; when owner |
| | reaches 70½, the spouse will be at least |
| | age 65 and the required distributions will |
| | not negatively impact the RIB) |
| | 5. RMD trigger may be measured off the |
| | Owner attaining age 70½ |
| | 6. The Qualified Spousal Guarantee will |
| | operate in a manner similar to the |
| | Nonqualified GRIS: 2 Covered Persons, |
| | benefit terminates at second death, spousal |
| | GRIS fee, RD based on youngest age of |
| | the 2 Covered Persons |

Purchasing a GRIS Policy

An exemplary process by which a client can acquire a GRIS policy is illustrated in FIG. 2. At step 200, the client communicates with a sponsor, e.g., in the context of receiving financial advice or purchasing investments. The communication can take many forms and can include telephonic, face-to-face, and/or electronic (e.g., web-based). At step 201, the client decides whether to purchase a GRIS policy. In one example, the client purchases the GRIS policy from a sponsor rather than directly from the Policy Issuer. Of course, the transaction could take many forms, including purchasing the GRIS directly from the Policy Issuer. If the client elects not to purchase a GRIS policy, the process ends at step 202. Importantly, however, the client is still free to purchase investment products or conduct other business with the sponsor. In some implementations, the guarantee is an optional product that is coupled to investment products provided by the sponsor to the client. In some implementations, the Policy Issuer and sponsor are distinct parties. More preferably, the Policy Issuer and sponsor are unrelated entities. In all implementations, the client does not liquidate his sponsor account to purchase a GRIS policy or transfer the assets to the Policy Issuer, but rather designates an account to pay the GRIS fee.

If the client elects to purchase a GRIS policy, at step 203 the client allocates funds that the policy will guarantee. The funds may be preexisting in an account with the sponsor, or the client may open and fund a new account. The Policy Issuer and/or sponsor may have restrictions on the types of assets that may be covered by the guarantee. There may also be restrictions on the risk profile of the assets or the minimum and/or maximum account balance. An example of a minimum balance is $250,000. In some implementations, the funds are invested in an asset allocation profile chosen from a collection of acceptable asset allocation portfolios 213. Because the GRIS insures against, among other things, poor market performance, the Policy Issuer has an interest in controlling the risk profile of the invested funds. Thus, the sponsor and Policy Issuer preferably develop asset allocation profiles that provide an acceptable balance of risk and return. There may be several asset allocations to choose from (e.g., three or more), each having a various distribution of securities such as equity securities, fixed income securities, mutual funds, exchange traded assets, derivatives, private funds and/or managed assets or other asset classes. Some asset allocations may include cash holdings. Some implementations may prohibit certain types of securities, e.g., stocks. In the described examples and implementations, the allocated assets may be referred to as Covered Assets. The Policy Issuer may have the option of terminating a GRIS if the account does not conform to an approved asset allocation portfolio.

Changes that a client makes to his account, including contributions and withdrawals, may temporarily cause the investments in the account to fall outside the parameters of an asset allocation portfolio. For example, if a client requests withdrawal of $100,000 from his account, the sponsor will sell securities that are worth $100,000 to raise cash for the withdrawal. At this point, the investments in the account may fall outside of the parameters of the asset allocation portfolio due to the higher percentage of cash held in the account. In addition, after the $100,000 is withdrawn, the remaining investments might not be within the parameters and the sponsor may need to rebalance the investments in the account. A grace period (e.g., five business days) may be provided from the Policy Issuer to the sponsor and/or client to cure this problem. If a withdrawal causes an account value to decrease to less than an asset allocation threshold value (e.g., $10,000), the sponsor may not be able to maintain the investments in the account within the parameters of an asset allocation portfolio. As a result, below that threshold value, the sponsor may have the option to liquidate the securities in such an account such that it only holds cash. Such an account will, under these circumstances, not be terminated for failure to conform to an asset allocation portfolio.

At step 204, the client elects whether to choose the individual guarantee or the spousal guarantee. As discussed above, the individual guarantee guarantees income until the death of the first Covered Person. The spousal guarantee guarantees income until the death of the last living spouse. If the client elects the individual guarantee, it is determined at step 214 whether the owner is a natural person (e.g., as opposed to a trust). If not, the client must name a natural person as a Covered Person 215. At step 205 the client must indicate whether it will be the sole owner of the certificate or whether there will be multiple owners. Depending on the client's choice, he will receive either a multiple owner individual guarantee 207 or a sole individual guarantee 206.

If the client elects the spousal guarantee, it is determined at step 208 whether the owners will be natural people (e.g., as opposed to a trust). If the owner is a non-natural person, the client must name two natural persons as the Covered Persons 211. The client may choose someone other than himself to receive the benefits of the guarantee and/or own the certificate. In most implementations, a natural person must be the owner of the GRIS. There may be an exception, however, for individual retirement accounts (“IRAs”). This is because the corresponding IRA asset account must be held in the name of the custodian. In addition, qualified GRIS may be offered to plans that are tax qualified under the Internal Revenue Code (e.g., “Qualified Plans”). Just like the IRA, the Qualified GRIS may be sold to trustees or custodians of Qualified Plans. Participants of Qualified Plans may choose either an individual guarantee or a spousal guarantee.

In some implementations, if the policy is purchased in connection with an IRA, the client must designate the natural person for whom the IRA is established as the owner of the policy for purposes of determining policy benefits. A “qualified” GRIS (i.e., one purchased in connection with an IRA) is held within the IRA account for the benefit of the natural person for whom the IRA is established. If a client wishes to provide spousal continuation rights to a surviving spouse in a qualified GRIS, the client will pay the GRIS fee associated with the spousal income guarantee. In some implementations, if a married person opts for a qualified GRIS, the client's spouse must be the death benefit beneficiary of the IRA account.

If the owner is a natural person and the client elects the spousal guarantee, it is determined at step 209 whether the protected spouses are legally married, e.g., as recognized by applicable Federal and/or State law. If so, the client may purchase the spousal guarantee 210. If joint ownership is not chosen, then one spouse may be the owner while the other may be the sole death benefit beneficiary 212. Restrictions on whether a couple is “married” may be based on federal law, state law, tax laws and/or regulations in effect at the time the policy is purchased. Alternatively, the sponsor and/or Policy Issuer may effect its own restrictions.

The term “beneficiary” is used in its broadest sense, e.g., to simply mean a party/entity that receives a benefit.

Operation of the Guarantee Aspect of the GRIS

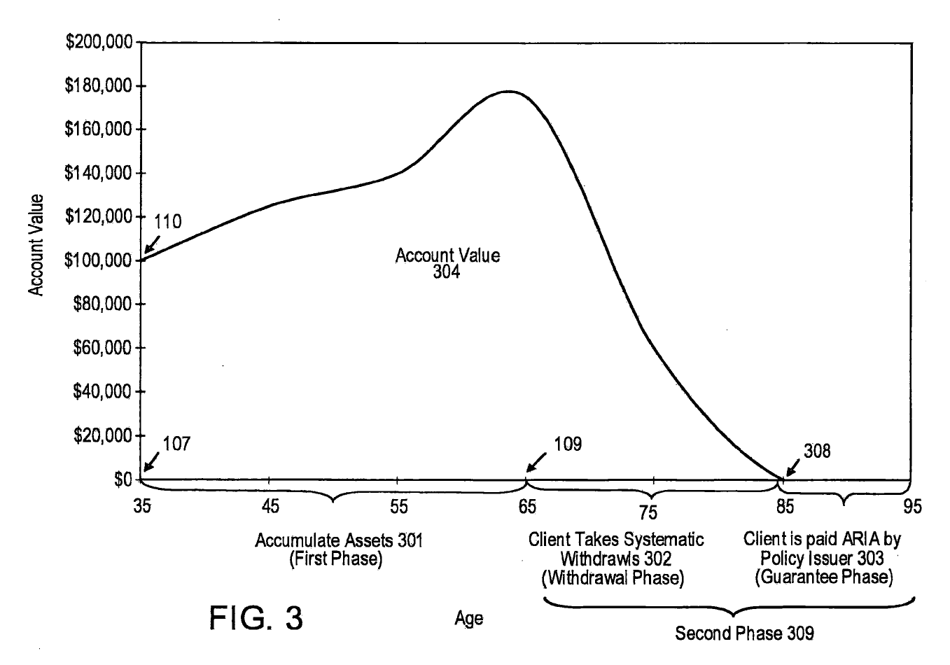

FIG. 3 graphically depicts the account value over time of an implementation of a GRIS. The illustration assumes that a client purchased a guarantee and opened a sponsor account at the same time. As discussed above, the date on which a client purchases a GRIS policy is referred to as the Certificate Date. Note that in FIG. 3, the X-axis represents the client's age and the Y-axis represents the sponsor account value.

Subject to certain conditions, the guarantee aspect of the GRIS insures against the risk that an investor will outlive certain mutual fund shares, brokerage account assets or other investments he or she has accumulated, by paying a lifetime annuity that begins when these assets are fully depleted and terminates upon death without any additional payments thereafter. Once lifetime income payments commence, it is preferred in some implementations that additional transactions cannot be processed against the sponsor account.

For purposes of this illustration of the guarantee aspect, certain parameters from the certificate 100 of FIG. 1 are utilized. Accordingly, the client initiated the sponsor account at 35 years of age and contributed $100,000 on the Certificate Date 107. The client's Retirement Income Base equals the amount of its initial contribution 110, i.e., $100,000. For purposes of this illustration, the client did not make additional contributions after the $100,000 initial contribution. This example relies on certificate 100 of FIG. 1, and therefore assumes that the policy specified that the Annual Retirement Income Amount (ARIA) would be 4% of the Retirement Income Base. It should be understood, however, that different policies can specify different Retirement Income Percentages, and that 4% is merely exemplary. Preferably, the range is between 0.25% and 25%. Some implementations may offer only a single RIP, e.g., 5%. Regardless, the ARIA is preferably calculated as follows, where RIB represents the value of the Retirement Income Base:
ARIA=RIP*RIB

As mentioned, ARIA is preferably first calculated on the Retirement Income Date. Some implementations use January 1 as a reference for calculating the ARIA. If the Retirement Income Date is January 1, the ARIA will be equal to the Retirement Income Percentage multiplied by the Retirement Income Base. However, if the Retirement Income Date is on a day other than January 1, the ARIA is pro rated based on the number of days until the following January 1. For example, if in a given year the Retirement Income Base on January 1 is $250,000, the RIP is 5% and the Retirement Income Date is on July 1, the ARIA is calculated on July 1 as $6,301.37 for the remainder of the year (5%*$250,000*184/365). In this example, the ARIA is recalculated on the January 1 of each subsequent calendar year and will be equal to 5% of the Retirement Income Base.

Moreover, this example includes a Retirement Income Date 109 that occurs when the client reaches age 65. Different policies can vary in the specification of the Retirement Income Date (indeed, some policies may omit it), so it should be understood that age 65 is merely exemplary. In the case where a client purchases a spousal GRIS (i.e., a married couple), the Retirement Income Date may be based on when the younger spouse reaches the age 65. If either the client or spouse dies before the Retirement Income Date, some implementations may recalculate the Retirement Income Date to be the later of the date of death or the surviving spouse's 65^{th} birthday. Again, the age 65 is merely exemplary, and may vary in this implementation as well.

In this example, the client waits thirty years until the Retirement Income Date 109 before taking withdrawals of his own assets to provide income payments for retirement (or other long-term purposes). Over this thirty year period 301 (accumulation phase), the assets appreciated to approximately $180,000 due to favorable market performance. In this simplified example, the client did not make any additional contributions to the sponsor account, and did not elect any of the Retirement Income Base increase options (e.g., 112, 114, and 115 of FIG. 1). Therefore, the client's Retirement Income Base remains at $100,000. The conditions and/or options that allow the Retirement Income Base to increase even without making additional contributions (e.g., Automatic Increase and/or roll up) are discussed in detail herein.

In this example, upon reaching the Retirement Income Date 109, the first phase terminates, and the client begins taking annual systematic withdrawals from the sponsor account in the amount up to the Annual Retirement Income Amount, or $4,000, which is 4% of the Retirement Income Base. This marks the beginning of the second phase (retirement phase) 309, and more particularly, the beginning of the withdrawal phase 302. All of the client's withdrawals within a given year (e.g., Certificate Year or calendar year) are Allowable Withdrawals if they do not, in total, exceed the Annual Retirement Income Amount. Allowable withdrawals do not decrease the Retirement Income Base. In some implementations, if a client does not withdraw the entire ARIA within a given year, he may not withdraw the difference in some later year (i.e., the difference is forfeited). In some implementations in which the GRIS is associated with an IRA account, the maximum ARIA may be adjusted to be equal to a required minimum distribution (“RMD”) of the IRA account. The RMD for IRA accounts is, in some implementations, calculated on each January 1 following the later of the policy effective date and the date the owner turns the age 70 1/2 (note that this age may vary with changes in the tax laws). Prior to the date the RMD is first calculated, the RMD is equal to $0. The RMD will be based on the account value on the previous December 31.

In this example, all withdrawals are Allowable Withdrawals. The client may continue to take withdrawals from the sponsor account until the investments are completely liquidated. The account value may also decrease if the value of the covered assets decreases due to, for example, a downturn in the financial markets. As shown, timeframe 302 (withdrawal phase) ends (at point 308) with the account value 304 at $0. It is at this point that the guarantee phase 303 begins. During this phase, annual income payments of $4,000 are paid to the client from the Policy Issuer because the guarantee pays the client lifetime income payments equal to the Annual Retirement Income Amount. In this example, these payments continue until the client dies.

The Retirement Income Base Can Vary

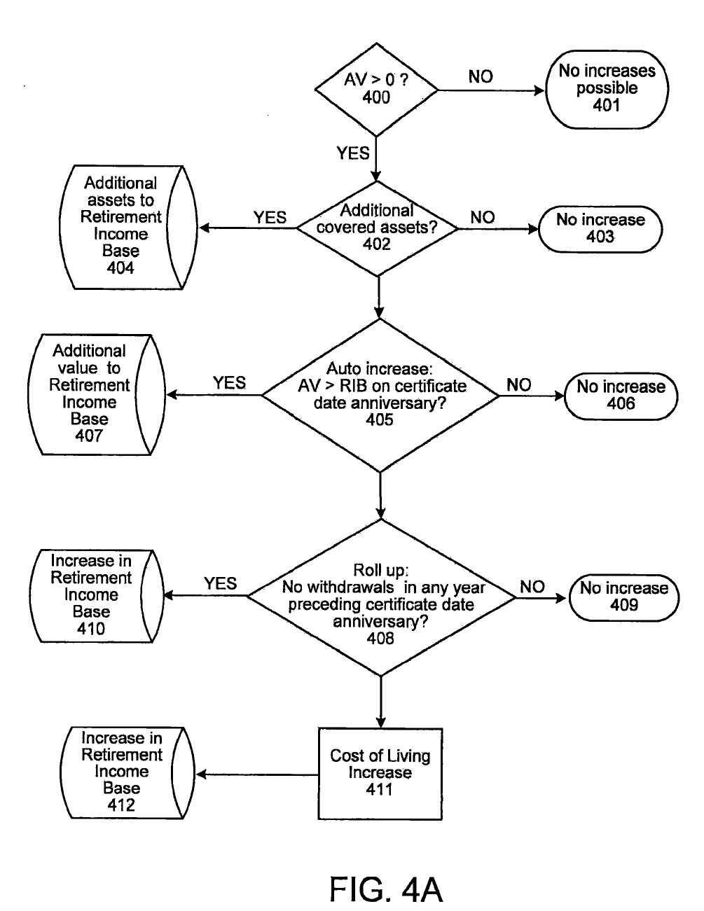

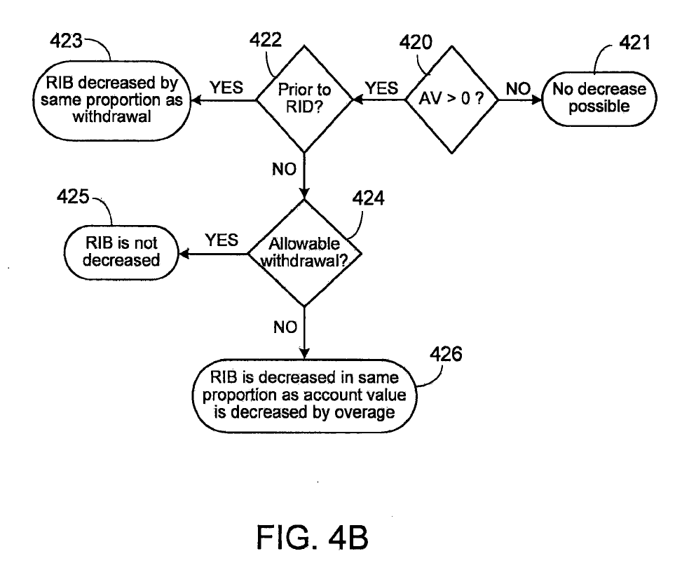

As mentioned, the Annual Retirement Income Amount is calculated based on the Retirement Income Base. However, the Retirement Income Base can vary throughout the life of the GRIS policy. Some ways that the Retirement Income Base can vary are discussed in connection with FIGS. 4A and 4B.

Retirement Income Base Increases

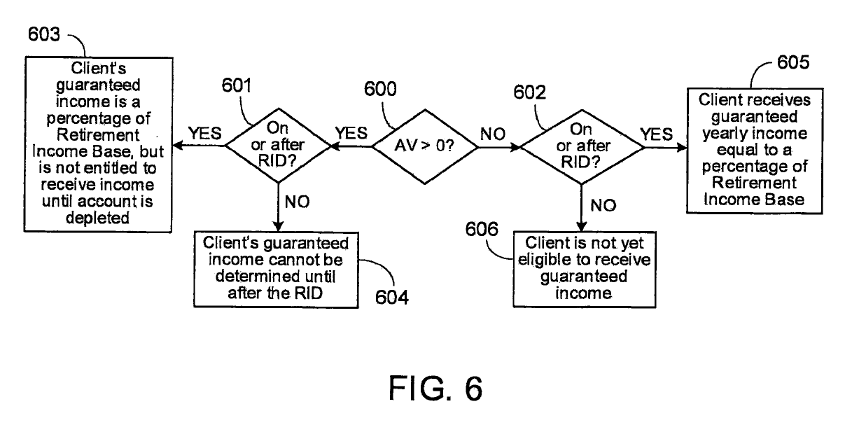

Generally speaking, the Retirement Income Base is used to calculate the client's Annual Retirement Income Amount. As mentioned above, on the Certificate Date, the Retirement Income Base is preferably equal to the value of the Covered Assets. Some ways (and related processes) that the Retirement Income Base can increase after the Certificate Date are illustrated with reference to FIG. 4A. As a threshold matter, it is determined at step 400 whether the client has any Covered Assets in his sponsor account, i.e., whether the client has a positive sponsor account balance. While the examples disclosed herein operate on a yearly basis, one of ordinary skill in the art will recognize that increases can be more or less frequent, or they may vary periodically (e.g., weekly, monthly, bi-yearly, etc.). Step 400 can occur as frequently as needed to administrate the Retirement Income Base procedures. If the client's sponsor account has been depleted, it is preferred that no Retirement Income Base increases are possible and the process ends at step 401. However, as discussed herein, (e.g., with reference to FIG. 6), the client may be eligible for lifetime income payments if his sponsor account value has been reduced to $0 or to some predetermined minimum amount. Alternatively, under some conditions, a zero balance terminates the certificate.

One manner in which the Retirement Income Base may increase is illustrated as step 402. If the client has purchased additional Covered Assets, those additional assets can be added to the client's Retirement Income Base at step 404. The Retirement Income Base will accordingly increase by the dollar amount of the newly purchased additional Covered Assets. Preferably, newly purchased additional Covered Assets do not include reinvestment of dividends or capital gains, proceeds from the sale of, or other accretions from Covered Assets within the client's sponsor account.

For example, with reference to exemplary certificate 100 of FIG. 1, on the Certificate Date the amount of Covered Assets equals $100,000 and, therefore, the Retirement Income Base equals $100,000. Assume that on the first Certificate Anniversary (which would occur, in this example, on Feb. 1, 2007), the client purchases and adds to its sponsor account newly purchased additional Covered Assets in the amount of $10,000. Assuming that during the first Certificate Year (i.e., in this example, from Feb. 1, 2006 to Feb. 1, 2007), the account value had not otherwise increased or deceased, the account value would increase to $110,000. Accordingly, the Retirement Income Base would increase to $110,000. In implementations that increase the RIB on the Certificate Anniversary, a formula that can be utilized to calculate the new Retirement Income Base due to additional Covered Assets is as follows, wherein RIBₙ represents the Retirement Income Base at Certificate Year n, RIBₙ₋₁ represents the Retirement Income Base at Certificate Year n−1, and ΔCA represents the amount of cumulative contributions on the date they were deposited from Certificate Year n−1 to n:
RIBₙ=RIB_{N-1}+ΔCA

Also, the RIB increase can—in some implementations—be calculated at points other than the end of a Certificate Year. One manner of calculating a new RIB is represented by the following formula, wherein RIB₂ represents the RIB as a result of the additional deposit, RIB₁ represents the RIB immediately prior to the additional deposit, D₂ represents the cumulative amount of deposits from the prior Anniversary Date up to and including the current additional deposit, W₂ represents the cumulative amount of withdrawals that did not reduce the RIB up to and including the time of the additional deposit, and I₁ represents the cumulative amount by which the RIB has increased as a result of prior contributions up to the point immediately prior to the current additional deposit:
RIB₂=RIB₁+D₂−W₂−I₁

In some implementations, an increase in the RIB will not instantly increase the ARIA. For example, if the RIB increases as a result of the purchase of additional assets or an additional cash contribution, the ARIA will increase by a proportionate amount based on the number of days remaining until the following January 1. Before the following January 1, the ARIA will increase by an amount equal to the Retirement Income Percentage multiplied by the amount that the RIB increased (as a result of the additional contribution) multiplied by the number of days until the following January 1 divided by 365. The client will have access to the full RIB increase by the next January 1. For example, presume a client has an RIP of 5%, and makes a $60,000 contribution on October 29 (which is 65 days until January 1). The increase in the ARIA would be equal to:
Increase=5%*$60,000*(65/365)=$534.25

If the client has not purchased additional Covered Assets, his Retirement Income Base will not increase in this manner (step 403).

Preferably, Retirement Income Base increases at steps 405, 408, and 411 are optional features that the client can opt for, and are preferably indicated in the client's certificate (e.g., certificate 100 of FIG. 1). Further, these increase options (405, 408, and 411) may not be available to all clients and/or from all sponsors.

The Automatic Increase option is depicted at step 405. The client's Retirement Income Base will increase on each Certificate Anniversary (e.g., with reference to exemplary certificate 100 of FIG. 1, Feb. 1, 2007, Feb. 1, 2008, Feb. 1, 2009, and so forth) if the client's sponsor account value is greater than its Retirement Income Base and the client chose the Automatic Increase. This situation can arise, for example, during periods of favorable market performance. The Retirement Income Base will be increased to equal the client's account value at step 407. In some implementations, the Automatic Increase is no longer available after a client makes a withdrawal.

For example, with reference to exemplary certificate 100 of FIG. 1, on the Certificate Date, the amount of Covered Assets equals $100,000 and, therefore, the Retirement Income Base equals $100,000. If by the first Certificate Anniversary (i.e., Feb. 1, 2007), the account value has grown to $120,000 because of, e.g., favorable market performance, the client's Retirement Income Base would be increased on Feb. 1, 2007 to $120,000. Of course, the Automatic Increases could occur with greater or lesser frequency in other implementations. If the client's account value has not appreciated within the Certificate Year, his Retirement Income Base will not increase in this manner (step 406).

In some implementations, the Automatic Increase does not take full effect until a target date such as January 1. In this example, where the policy anniversary date is February 1 rather than January 1, the client may have immediate access to only a proportionate amount of the ARIA based on the number of days remaining in the calendar year. On the following January 1, the client would have access to the full amount. For example, if a client has an RIP of 4% and the account value increased by $20,000, since 333 days remain from February 1 until January 1, the ARIA increase would be calculated as follows:
Increase=4%*$20,000*(333/365)=$729.86

Preferably, the Policy Issuer and/or sponsor has the option of increasing the MRIFP on the date of any Automatic Increase. Preferably, before an MRIFP increase due to the Automatic Increase occurs, the client will be notified. Therefore, the client will be afforded the opportunity to decline the Automatic Increase and associated MRIFP increase. In some implementations, once a client declines an Automatic Increase, the client will no longer be eligible for future Automatic Increases unless client provides notice that he wishes to reinstate the Automatic Increase option. The Automatic Increase and the MRIFP then in effect will be resumed on the Certificate Anniversary following the date the client provides notification to reinstate the Automatic Increase option. In still other implementations, the Automatic Increase is not the default, and a client must specifically request the Automatic Increase. In some implementations, clients are automatically opted into the Automatic Increase if the MRIFP has changed less than a threshold amount. For example, in some implementations, clients are automatically opted into the Automatic Increase if the MRIFP has increased by less than 0.5%.

The roll up option is illustrated at step 408. If the client so elected in his certificate, his Retirement Income Base will increase on each Certificate Anniversary (e.g., with reference to exemplary certificate 100 of FIG. 1, Feb. 1, 2007, Feb. 1, 2008, Feb. 1, 2009, and so forth) during the predefined period following the Certificate Date if the client has not made any withdrawals from his sponsor account. Depending on the terms of the certificate, which may vary, the predefined period can be any desired timeframe, e.g., 5 years from the Certificate Date, 1200 days from the Certificate Date, etc. On the Certificate Anniversary, the client's Retirement Income Base will be increased by an amount equal to a predetermined percentage multiplied by the Retirement Income Base on the prior Certificate Anniversary. A formula that can be used to calculate the new Retirement Income Base with the roll up is as follows, wherein RUIP represents the roll up increase percentage:
RIBₙ=RIBₙ₋₁*(1+RUIP)

To illustrate with reference to exemplary certificate 100 of FIG. 1, on the Certificate Date, the amount of Covered Assets equals $100,000 and, therefore, the Retirement Income Base equals $100,000. Further, as specified in certificate 100, the roll up increase percentage is 5% of the client's Retirement Income Base (see item 115). On the first Certificate Anniversary, if the client has not made any withdrawals in the year, the Retirement Income Base will be increased by an amount equal to 5% multiplied by $100,000. Therefore, on the first Certificate Anniversary (i.e., Feb. 1, 2007 in this example), the new Retirement Income Base would equal $105,000. On the second Certificate Anniversary (i.e., Feb. 1, 2008 in this example), if the client has not made any withdrawals in the year, the Retirement Income Base will be increased by an amount equal to 5% multiplied by $105,000. Therefore, on the second Certificate Anniversary, the new Retirement Income Base would equal $110,250. In different certificates, the predetermined percentage can vary, and can equal, e.g., 2%, 2.5%, 4.5%, etc. Further, there is no requirement that the roll up increase percentage be different than the retirement income percentage. Of course, roll up increases could occur with greater or lesser frequency in other implementations. In this implementation, if the client has ever made withdrawals, the Retirement Income Base will not be increased in this manner (step 409). In other implementations, if the client has not made a withdrawal within a given Certificate Year, he is eligible for the Roll Up.

In some implementations, there may be a maximum roll up increase. The maximum may be defined, e.g., by a flat maximum amount (e.g., in dollars) or a maximum percentage (e.g., of the cash contribution).

The cost of living option is illustrated with reference to step 411. If the client so elects in his or her certificate, its Retirement Income Base will increase on each Certificate Anniversary by a predetermined percentage preferably selected to reflect the increase in the cost of living and may, in some implementations, be tied to a market index. The new Retirement Income Base with cost of living increase can be calculated with the following formula, wherein COLA represents the cost of living increase amount on year n, COLP represents the cost of living increase percentage (see item 114), and ACA represents the cumulative amount of additional Covered Assets during the prior Certificate Year:
COLA=(RIBₙ−ACA)*COLP

The increase (COLA) is added to the client's Retirement Income Base as per step 412. Illustrating this increase with reference to exemplary certificate 100 of FIG. 1, on the Certificate Date, the amount of Covered Assets equals $100,000 and, therefore, the Retirement Income Base equals $100,000. As specified in exemplary certificate 100, the cost of living increase percentage is 3% (see item 114). On the first Certificate Anniversary (in this example, Feb. 1, 2007), the Retirement Income Base would be increased by an amount equal to 3% multiplied by $100,000. On the first Certificate Anniversary, the new Retirement Income Base would equal $103,000. If by the second Certificate Anniversary, the client contributed an additional $10,000 of covered assets, the Retirement Income Base would equal $113,000. However, because additional covered assets are excluded from the cost of living calculation, on the second Certificate Anniversary (Feb. 1, 2008 in this example), the Retirement Income Base would be increased by an amount equal to 3% multiplied by $103,000. On the second Certificate Anniversary, the new Retirement Income Base would equal $116,090 ($113,000+$3,090). The cost of living increase percentage could be a percentage other than 3% (e.g., 1%, 2.25%, 4%), and moreover, it could be a dynamic percentage that is based an outside indicator of the cost of living (e.g., the consumer price index). Further, a client may choose not to elect the cost of living increase option. If that is the case, the Retirement Income Base will not increase in this manner.

In some implementations, the cost of living increase occurs only after the Account Value is equal to $0 (or some other predetermined minimum), and the increase is applied to the ARIA. In some implementations, the cost of living increase occurs only before the Retirement Income Date, and the increase is applied to the Account Value or RIB.

Despite the ways in which the Retirement Income Base may increase, the sponsor and/or Policy Issuer may institute a maximum allowable Retirement Income Base. This maximum can affect initial funding (e.g., at step 203 of FIG. 2) as well as subsequent increases. The maximum amount can be set on, e.g., an account-by-account basis, investment class basis, and/or an overall basis.

The RIB may increase, for example, as a result of additional contributions, COLA, Roll-Up or Automatic Increase. Depending on the implementation, the RIB may increase immediately or on the next-recalculation date. The ARIA may increase when the RIB increases (pro-rated based on the number of days until the next re-calculation date) or the ARIA may not increase until the next re-calculation date, in which case the ARIA=RIP*RIB on the next re-calculation date.

Retirement Income Base Decreases

Some ways (and related processes) that the Retirement Income Base can decrease after the Certificate Date are illustrated with reference to FIG. 4B. As a threshold matter, it is determined at step 420 whether the client has any Covered Assets in his sponsor account, i.e., whether the client has a positive balance. If the client's sponsor account has been depleted, no Retirement Income Base decreases are possible and the process ends at step 421. However, as discussed herein e.g., with reference to FIG. 6, the client may be eligible for lifetime income payments if his sponsor account value has been reduced to $0 or to some predetermined minimum amount. Alternatively, under some conditions, a zero balance terminates the certificate.

If the client does have Covered Assets, the next step is determining whether it is prior to the Retirement Income Date (step 422). In this example, withdrawals from the sponsor account before the Retirement Income Date, or withdrawals after the Retirement Income Date in excess of the Annual Retirement Income Amount are generally the cause for decreases in the Retirement Income Base. Note that it is preferred that if a client withdrawals his entire account value such that his Retirement Income Base is reduced to $0, his certificate will terminate. If it is prior to the Retirement Income Date specified in the certificate (e.g., certificate 100 of FIG. 1), the Retirement Income Base will be reduced by the withdrawal in the same proportion as the account value (immediately prior to the withdrawal) is reduced by the withdrawal (step 423). The decrease can be calculated as follows, wherein RIBD represents the Retirement Income Base decrease, W is equal to the withdrawal amount, and AV represents the account value immediately prior to the withdrawal
RIBD=RIB*(W/AV)

For example, with reference to exemplary certificate 100 of FIG. 1, the annual retirement income amount is 4% of the Retirement Income Base. On the Certificate Date (Feb. 1, 2006, in this example), the amount of Covered Assets equals $100,000 and, therefore, the Retirement Income Base equals $100,000. For purposes of this illustration, on the first Certificate Anniversary (Feb. 1, 2007), the client withdraws $4,000 from the account. Also for purposes of this illustration, during the first Certificate Year (Feb. 1, 2006 through Feb. 1, 2007) the account value had not increased or decreased and that therefore the account value would decrease to $96,000 as a result of the withdrawal. The client's Retirement Income Base would be reduced in the same proportion that the withdrawal reduced the account value. The account value was reduced by 4%; hence, the Retirement Income Base is reduced by 4%. Therefore, the client's Retirement Income Base after the withdrawal would be $96,000.

In further illustration, on the second Certificate Anniversary (Feb. 1, 2008 in this example), the client makes a withdrawal of $10,000 from the account. Again, for this illustration, there has otherwise been no increase or decrease in the account value. The account value would decrease to $86,000 as a result of the withdrawal. The Retirement Income Base would be reduced in the same proportion that the withdrawal reduced the Account Value, and therefore, the Retirement Income Base after the withdrawal would be $86,000.

In some implementations, the client has the option of restoring the Retirement Income Base to its amount prior to the withdrawal that decreased the RIB by making a deposit. For example, in the above illustration, the client could have deposited $10,000 within a predetermined time period (e.g., 30 days) and immediately restored the ARIA by increasing the RIB to $96,000 (i.e., as opposed to a simple deposit that increases the ARIA on a pro-rata basis). This may be implemented as an optional feature that requires an increased MRIFP. Also, a fee may be assessed for this restoration process. For example, the client may have to deposit a sum larger than $10,000 to restore the ARIA to its pre-withdrawal amount.

For purposes of further illustration, on the third Certificate Anniversary (Feb. 1, 2009 in this example), the client withdraws $86,000 from his account (the entire account value). The account value would decrease to $0, and so would the Retirement Income Base. Because the client's Retirement Income Base after the withdrawal would be $0, the client's Certificate will terminate.

If the withdrawal is on or after the Retirement Income Date, it is determined at step 424 whether the withdrawal was allowable. Preferably, the Retirement Income Base will not be reduced as long as the cumulative amount of withdrawals made in a Certificate Year is less than or equal to Annual Retirement Income Amount (step 425). However, if the cumulative amount of withdrawals made in a Certificate Year is greater than the client's Annual Retirement Income Amount, the Retirement Income Base will be reduced by each withdrawal as of the effective date of each withdrawal in the same proportion as the account value (preferably immediately prior to each withdrawal) is reduced by the amount beyond the Annual Retirement Income Amount (step 426). The Retirement Income Base decrease can be calculated as follows, wherein W is equal to the cumulative amount of withdrawals greater than the ARIA within a Certificate Year:
RIBD=RIB*(W/AV)

In some implementations, W is equal to the cumulative amount of withdrawals greater than the ARIA within a calendar year rather than a Certificate Year.

With respect to the exemplary certificate 100 of FIG. 1, the Annual Retirement Income Amount is 4% of the Retirement Income Base. On the Certificate Date (Feb. 1, 2006 in this example), the amount of Covered Assets equals $100,000 and, therefore, the Retirement Income Base equals $100,000. For purposes of this illustration, the Retirement Income Date has passed, and neither the account value nor Retirement Income Base has changed. As such, the Annual Retirement Income Amount equals $4,000. That year, the client withdraws of $4,000 from the account. The Account Value would decrease to $96,000 as a result of the withdrawal, but because the cumulative withdrawals did not exceed the Annual Retirement Income Amount, the Retirement Income Base would remain at $100,000. Such a withdrawal is an example of an allowable withdrawal (e.g., step 425).

Later that year, the client withdraws an additional $12,000 from the account. The account value has not otherwise increased or decreased since the prior withdrawal. The account value would decrease to $84,000 as a result of the second withdrawal. The cumulative withdrawals for the year are now $16,000 which exceeds the Annual Retirement Income Amount of $4,000. Therefore, the Retirement Income Base will be reduced by 12.5% due to the second withdrawal (e.g., step 426). Therefore the client's Retirement Income Base becomes $87,500.

Depending on the implementation, withdrawals may take the form of: (i) the sale or exchange of investments in an account that are not reinvested in an asset allocation strategy; (ii) the sale, exchange or transfer of investments to pay a financial advisor's fee; (iii) the transfer of investments out of the account; or (iv) dividends, capital gains or other accretions paid into the account that are not reinvested in the account in accordance with the target ranges of the asset allocation strategies. In some implementations, however, the sale, exchange or transfer of investments to pay the GRIS fee, the investment advisor's fee, or the sponsor program fee will not be treated as a withdrawal.

Data Exchange Topology

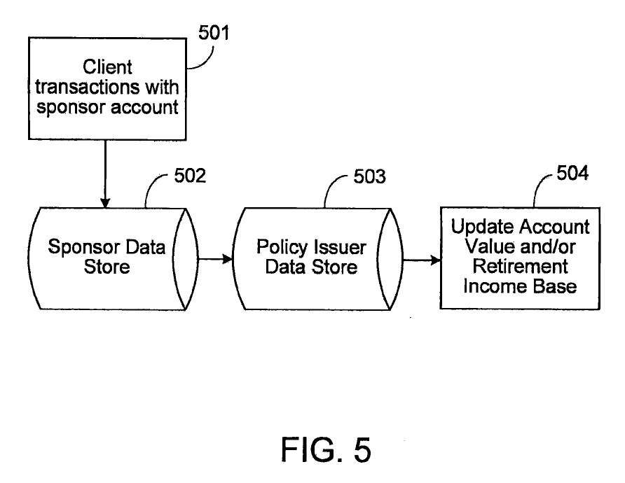

Preferably, the sponsor will administer client requests for withdrawals. The Policy Issuer will preferably receive information periodically from the sponsor concerning clients' account values and transactions processed in clients' sponsor accounts. The sponsor will also preferably provide the Policy Issuer with historical daily or monthly returns for each asset allocation strategy it offers. The Policy Issuer can thusly track clients' account values and transactions to calculate the amount of each client's account value, Retirement Income Amount, and/or Annual Retirement Income Amount, if any, on an ongoing basis. An exemplary method for that data exchange is illustrated in FIG. 5. Whenever there is a client transaction with the sponsor account 501 (or any other event that affects the balance therein), the sponsor's data store 502 is updated. That update is then transferred to the Policy Issuer data store 503. Updates preferably occur at least weekly, but other frequencies are possible (e.g., hourly, daily, monthly). In some implementations, consistency checks between the sponsor's data store 502 and Policy Issuer data store 503 occur periodically. The Policy Issuer data store 503 is then used to update 504 the Policy Issuer's record of the client's account value or Retirement Income Base (depending on whether the transaction affects one or both, see, e.g., discussion of FIGS. 4A and 4B). An architecture to effect the data exchange between the sponsor(s) and the Policy Issuer(s) is discussed in more detail herein.

The Annual Retirement Income Amount

As described, the Annual Retirement Income Amount is an aspect of various implementations of the GRIS. In the described examples, the Annual Retirement Income Amount has at least two purposes. A first purpose is to inform the client of the maximum amount of withdrawals that may be taken in certain years without negatively impacting the Retirement Income Base and the amount of Annual Retirement Income Amount payments (i.e., with respect to allowable withdrawals). A second purpose is to specify the amount of income payments the Policy Issuer may be obligated to pay the client after its retirement income date and after its account value decreases to $0, until the client's death (or, in some implementations, the last living spouse's death).

The status of and the client's entitlement to the Annual Retirement Income amount are subject to several threshold inquiries, some of which are described in connection with FIG. 6. Variations on these methods are possible, e.g., the Retirement Income Date Inquiry may occur before the Account Value Inquiry.

First, at step 600, it is determined whether the Account Value is greater than $0. If so, the next inquiry is whether it is on or after the Retirement Income Date (step 601). If it is on or after the Retirement Income Date, the client's Annual Retirement Income Amount (ARIA) is equal to the client's retirement income percentage multiplied by his Retirement Income Base. However, because the client has a positive account balance, he is not entitled to be paid the Annual Income Retirement Amount from the Policy Issuer until his account value has been depleted (step 603). He is, however, entitled to withdraw from his account on a yearly basis an amount equal to his ARIA. In other words, the client is entitled the withdraw the ARIA from his own assets, but is not yet eligible to be paid the ARIA from the Policy Issuer. For example, with reference to exemplary certificate 100 of FIG. 1, if the date is Mar. 5, 2037 (i.e., after the Retirement Income Date 109), and the account value is still $100,000, the client is not yet entitled to receive the Annual Retirement Income Amount. Note that depending on how the account value is depleted, it can affect the Annual Retirement Income Amount (see, e.g., discussion of FIG. 4B). In some implementations, this and related methodologies can be modified such that a $0 balance is not required. For example, a predetermined minimum amount could be any amount less than the Annual Retirement Income Amount. In such implementations that do not require a $0 balance, the owner may be given the option whether to (1) begin receiving the ARIA once the account value reaches the predetermined minimum amount or (2) wait until the assets reach $0.

If the Retirement Income Date has not yet arrived, it is preferred that the Annual Retirement Income Amount is not yet determined and/or communicated to the client (step 604). For example, with reference to exemplary certificate 100 of FIG. 1, although the Retirement Income Percentage and Retirement Income Base are both known values, the client's Annual Retirement Income Amount is preferably not known until Feb. 1, 2036 (the Retirement Income Date). Moreover, prior to reaching the Retirement Income Date, the client does not have access to the Annual Retirement Income Amount. Indeed, any time a client makes a withdrawal prior to the Retirement Income Date, his Retirement Income Base will preferably be reduced (see, e.g., discussion of FIG. 4B).

Alternatively, if it is determined at step 600 that the client's account value is $0, it must again be determined whether it is on or after the Retirement Income Date (step 602). If it is prior to the Retirement Income Date, the client is not yet eligible to receive income payments (step 606). The client must wait until he reaches the Retirement Income Date. For example, with reference to the exemplary certificate 100 of FIG. 1, if the client's account value decreases to $0 on Feb. 1, 2035, he is not eligible to begin receiving payments until Feb. 1, 2036 (at the earliest). If, however, the account value is $0 and the Retirement Income Base is also $0, the certificate terminates.

If it is on or after the Retirement Income Date and the client's account value has decreased to $0 (and a Retirement Income Base still exists), the Annual Retirement Income Amount is the amount that will be paid to the client from the Policy Issuer each year for life. Preferably, monthly payments to the client will commence one month following the date the client's account value decreases to $0. For example, with reference to exemplary certificate 100 of FIG. 1, if the client's account value decreases to $0 on Mar. 2, 2036, it is preferred that monthly payments will begin on Apr. 2, 2036 and be paid until the client's death. Had the client of certificate 100 elected the spousal guarantee, payments would continue until the death of the last living spouse. While the preferred payment frequency is monthly (e.g., monthly payments equal to one-twelfth of the client's Annual Retirement Income Amount) the client, sponsor, and/or Policy Issuer can request and effect an alternative payment frequency. Moreover, if the client's monthly payments are less than a threshold value, the sponsor and/or Policy Issuer can change the frequency of payments (e.g., quarterly, semi-annually or annually). The sponsor and/or Policy Issuer may exercise this option if the client's monthly installment of the Annual Retirement Income Amount is sufficiently small that the administrative costs of making twelve payments per year become comparatively burdensome.

Terminating a GRIS Certificate

There are several ways in which a certificate can be terminated. Some examples of those ways are described herein. A client may terminate its certificate at any time, preferably, in accordance with established administrative procedures. If a client terminates its certificate, it is preferred that no amount of the fees will be returned to the owner.

Alternatively, the certificate can terminate automatically. Automatic termination can be triggered by events such as those described herein. For example, if there is only one Covered Person, the certificate will terminate upon the death of the Covered Person.

If there are two or more Covered Persons, and the individual income guarantee is in effect, the certificate will terminate upon the first death of a Covered Person. If there are two Covered Persons, and the spousal income guarantee is in effect, upon the first death of a Covered Person, the surviving spouse becomes the sole owner (sole Covered Person) of the certificate, and the certificate continues automatically unless the spouse elects not to continue. If the spouse elects not to continue, the certificate will terminate. If the certificate continues with the surviving spouse as sole Covered Person, the rights and obligations under the certificate are unchanged. Upon the death of the surviving spouse, the certificate will terminate (see also section below regarding divorce). If the Retirement Income Base is reduced to $0 due to withdrawals, the certificate will terminate. If the client, for example, changes financial advisors and the new financial advisor is not affiliated with an approved sponsor who is approved to make the certificate available to clients, the certificate will terminate. The certificate will terminate if Covered Assets are invested in an asset allocation strategy where the sponsor of the previously approved asset allocation strategy changes its investments in any manner without the Policy Issuer consent (but see the discussion above regarding the cure period).

If the client opts for the Lifetime Payment Option, the certificate will terminate.

Prior to the client's sponsor account reducing to $0, the client may elect the Lifetime Payment Option. If this option is elected, the client must liquidate the client sponsor account and contribute the proceeds to purchase a separate supplemental lifetime fixed immediate annuity contract from the Policy Issuer. If the Lifetime Payment Option is elected, the certificate will terminate.

The above described conditions of termination are merely exemplary and that there may be other such termination conditions.

Divorce

In some implementations where a GRIS policy is owned jointly by spouses, in the event of a divorce that becomes final before the account value is reduced to $0, the former spouses must provide written notice to the sponsor and/or Policy Issuer regarding the divorce stating whether (1) the former spouses will divide the assets in the account, (2) one former spouse will remain the sole owner of the account, or (3) both former spouses will remain owners of the account.

Before the account value is reduced to $0, if the former spouses provide notice that they will divide the assets in the account between two new accounts, the jointly owned spousal GRIS policy will be converted to two individually owned GRIS policies, one for each of the two new accounts. The current MRIFP applicable to individually owned GRIS policies will be charged. The Retirement Income Base from the original account will be allocated between the two new accounts owned by each former spouse, as agreed by the former spouses or as directed by any valid, applicable court order. Other information on the Certificate may be changed as well, e.g., name or Retirement Income Date. Until such notice is received, both former spouses will continue to be treated as the owners of the account and will continue to be charged the MRIFP applicable to jointly owned spousal policies.

However, effective as of the date of the divorce, the policy will no longer be a “spousal” jointly owned policy and the policy will generally terminate upon the first owner's death if such death occurs before notice is received of the divorce and division of the assets of the account and the policy is converted into two individually owned policies. However, if such death occurs before notice is received of the death, but written evidence is provided that establishes that prior to the first former spouse's death, the assets in the account were legally divided either (i) by operation of applicable state law (e.g., laws of community property states) or (ii) pursuant to a court mandated property settlement that sets forth precisely how the former spouses' account assets are to be divided, rather than terminating the policy, the jointly owned GRIS policy will be converted into an individually owned GRIS policy for the account of the surviving former spouse. The Retirement Income Base applicable to the original account will be allocated to the policy for the account of the surviving spouse, in accordance with such applicable law or property settlement, as the case may be. The portion of the Retirement Income Base from the original account that is attributable to the deceased former spouse under such applicable state law or property settlement will be reduced to $0 and the GRIS policy will be terminated as to the assets in the account attributable to the deceased former spouse, as of the date of such deceased former spouse's death.

If the former spouses provide notice that only one of the former spouses will remain an owner of the account, which was previously owned by the former spouses, the jointly owned spousal GRIS policy will be terminated and an individually owned policy will be issued to the sole owner. Until such notice is received, both former spouses will continue to be treated as the owners of the account and will be charged the MFIRP applicable to jointly owned spousal policies until notice is received that the spouses are divorced. However, effective as of the date of the divorce, upon the death of the former spouse who is to remain the sole owner of the account, the policy will terminate upon the death of such former spouse, even if such death occurs before notice is received that the former spouse is to remain the sole owner of the account.

If the former spouses are to remain the joint owners of the account, the former spouses will continue as the joint owners and no change will be made to the ownership of the policy. However, as of the effective date of the divorce, the policy will no longer be a “spousal” jointly owned policy and the policy will terminate upon the first owner's death, even if such death occurs before notice is received of the divorce. The fee applicable to individually owned policies will then be charged.

On or after the account value is reduced to $0, if a GRIS policy is jointly owned by spouses, in the event of a divorce that becomes final on or after the account value is reduced to $0, the income payments will be split according to, e.g., a written notice of divorce or divorce decree. Prior to receipt of the written notice of divorce, income payments due under the GRIS will be made in the manner prescribed by the former spouses pursuant to the terms of the policy.

GRIS Fees

Clients are, in most implementations, required to pay a periodic fee for the GRIS (MRIFP). In some implementations, the fee is payable quarterly in advance on the first day of each calendar quarter. As discussed, the GRIS fee is a percentage of the Retirement Income Base.

The GRIS fee can be deducted from the client's account or another designated account. In addition, the GRIS fee may be a service class fee assessed against service class shares of a mutual fund in compliance with federal and state law. The GRIS fee may be remitted to the Policy Issuer by the sponsor, the third party provider of the designated account, or the client. The MRIFP may vary, and may be higher with respect to any additional contributions a client makes to his account or if the client exercises the Automatic Increase, Roll-Up, and/or Cost of Living Options. In some implementations, the MRIFP for the Spousal Income Guarantee may be different from the MRIFP for the Individual Income Guarantee. Generally speaking, for some implementations, if a client's Retirement Income Base does not change, his MRIFP and the dollar amount of the GRIS fee will not change.

In some implementations, the MRIFP is a percentage of the account value. In some implementations, the MRIFP is a percentage of the account value or RIB, or whichever amount is greater.

In some implementations, if a client makes additional contributions to his account, his MRIFP will be calculated as a weighted average fee on the new value of Retirement Income Base, which reflects the additional contributions. In some implementations, if a client exercises the Automatic Increase, the current MRIFP will apply to the new increased Retirement Income Base. The new GRIS fee for an increased RIB may be a higher percentage than the GRIS fee on the previous RIB balance. Additionally, even if the GRIS fee for an increased RIB remains unchanged, the dollar amount of the GRIS fee will increase because the RIB will be higher.

In some implementations, the sale or transfer of investments in a client's account to pay the GRIS fee is not treated as a withdrawal for purposes of determining lifetime income payments. Generally speaking, the GRIS fee is paid in advance and will not be refunded in any portion if a policy is terminated for any reason.

The sponsor and/or Policy Issuer reserves the right to increase the MRIFP for additional contributions or if a client exercises the Automatic Increase Option, Roll-Up Option, and/or Cost of Living Option. The sponsor and/or Policy Issuer may raise the MRIFP to the MRIFP charged to the new policies at the time of the additional contribution or the exercise of the Automatic Increase Option, Roll-Up Option, and Cost of Living Option. In some implementations, the MRIFP will be capped, e.g., no greater than 5% of the Retirement Income Base.

For example, assume that a Retirement Income Base is equal to $250,000 and the MRIFP currently in effect for that policy is 0.85%. Assume further that the client makes an additional contribution of $50,000 and the MRIFP applicable to additional contributions at the time of the contribution is equal to 0.90%. The Retirement Income Base increases to $300,000 as a result of the additional contribution. The weighted average MRIFP is equal to the current MRIFP multiplied by the Retirement Income Base before the additional contribution (0.85%*$250,000) plus the new MRIFP multiplied by the amount the Retirement Income Base increased as a result of the additional contribution (0.90%*$50,000) divided by the new Retirement Income Base ($300,000). The result is 0.86%. The new weighted average MRIFP of 0.86% will be applied at the end of the next quarter and thereafter, assuming no other changes. A exemplary formula for deriving the fee, wherein F_{N} means the new fee, F₁ means the fee at time 1, F₂ means the fee at time 2, RIB₁ means the RIB immediately before the contribution and C₂ represents the amount the RIB increases due to the contribution at time 2, is as follows:
F_{N}=[(F₁*RIB₁)+(F₂*C₂)]/(RIB₁+C₂)

In another example, assume that the RIB is equal to $250,000 and the MRIFP currently in effect is 0.85%. Assume on the first policy anniversary date the account value is equal to $300,000 and the MRIFP then in effect is 0.90%. If the client exercises the Automatic Increase, the Retirement Income Base will increase from $250,000 to $300,000 and the MRIFP will increase to 0.90%. The sponsor and/or Policy Issuer will use 0.90% to calculate the GRIS fee at the end of the next calendar quarter.

In some implementations, the GRIS fee can be a fixed fee, i.e., one that is not based on the Retirement Income Base or any other value of the account. In some implementations, the MRIFP may increase or decrease from time to time at the discretion of, e.g., the Policy Issuer.

Other Implementations

In some implementations, the ARIA is not paid for period equal to a Covered Person's lifetime. Instead, the ARIA may be paid for a period certain, in a lump sum or in a combination feature with the lifetime benefit.

In some implementations, if the account has been reduced to $0 and benefit payments have commenced, upon death of the Covered Person, the Policy Issuer will continue to make payments to the beneficiary until the sum of all contributions has been returned to the client/beneficiary either through withdrawals and/or benefit payments. Alternatively, the Policy Issuer may pay a lump sum in lieu of continuing to make payments.

For example, assume that the Covered Assets on the Certificate Date equal $150,000. Additional contributions were made to the account in the amount of $30,000 over the life of the policy. The client took cumulative withdrawals from the account equal to $70,000. The account was reduced to $0 and the client received benefit payments for 3 years (equal to $10,000/year) until his death. At the time of death, the client had received a total of $100,000 in benefit payments. Under the period certain option, his beneficiary would receive payments of $10,000/year for 8 years. Under the lump sum option, the beneficiary would receive a lump-sum of $80,000 ($150,000+$30,000-$70,000-$30,000).

In yet other implementations, the Certificate may include a Benefit End Date, which sets a date (or age of a particular party) at which ARIA payments end. Other implementations may include a Maximum Benefit Outlay (“MBO”), which allows the Policy Issuer to set a maximum amount of benefits to be paid to the client (or beneficiary). For example, if the MBO is $1,000,000, ARIA payments will end once the Policy Issuer has paid $1,000,000 in benefit payments.

Data Processing Architecture

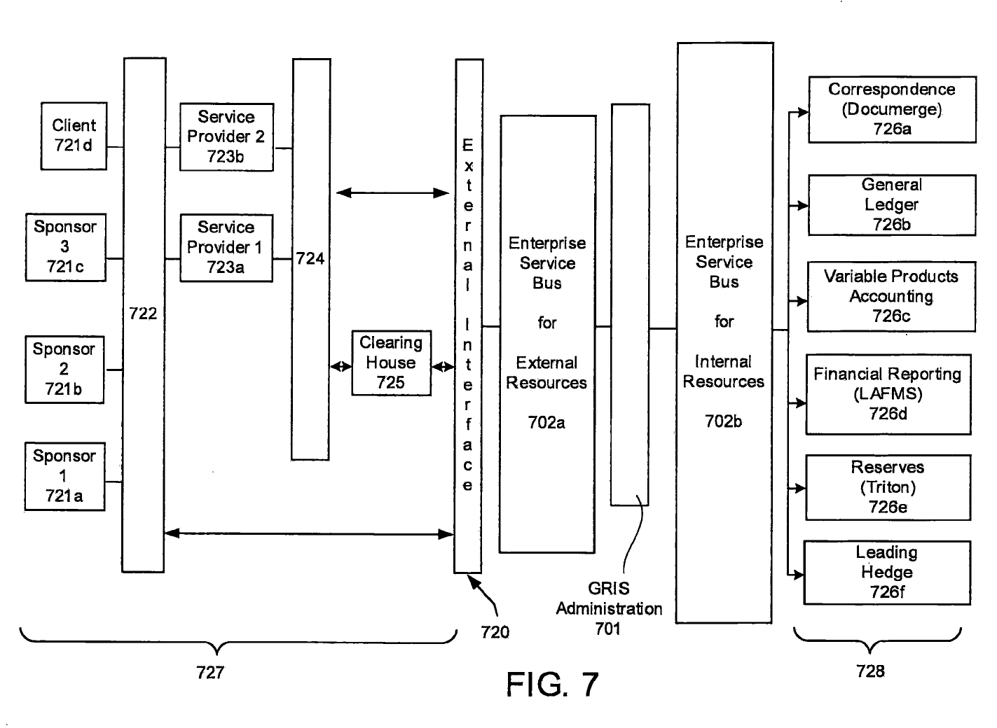

The Policy Issuer, sponsor(s), clients and/or other parties exchange data to orchestrate features of some implementations. This is preferably implemented via a data exchange system comprising various information technology (IT) hardware and software. An overview of an implementation of such a data exchange system is illustrated schematically in FIG. 7. One feature of FIG. 7 is the GRIS Administration server 701. Server 701, preferably in combination with the exchange of data from sponsors and/or clients, is used to implement at least in part the guarantee of FIG. 3 and the methods disclosed in connection with FIGS. 2, 4A, 4B, 5 and 6.

The server 701, to accomplish administration of the GRIS, interfaces with both internal (728) and external (727) resources. Enterprise service bus 702a interfaces with external resources 727 whereas enterprise server bus 702b interfaces with internal resources 728. An example of appropriate enterprise server bus architecture includes those available from SeeBeyond™ (now a division of Sun Microsystems, Inc.). While having separate enterprise service buses 702a and 702b is sometimes preferred for security reasons (e.g., to prevent outsiders from reaching internal Policy Issuer resources), it is possible to integrate 702a and 702b into a single enterprise service bus.

Enterprise service bus 702b allows the server 701 to interface with other internal resources, e.g., correspondence resources 726a (e.g., for automatic creation of correspondence to clients), general ledger 726b (e.g., for internal accounting), variable products accounting 726c (e.g., for internal accounting), financial reporting resources 726d (e.g., for generating data for regulatory purposes), reserves 726e (e.g., for determining reserves for regulatory purposes) and leading hedge 726f (e.g., for maintaining proper hedging).

Enterprise service bus 702a enables the server 701 to interface with hardware and software aside from the Policy Issuer's internal resources. Preferably, at least one external interface 720 is utilized between the enterprise service bus 702a and the outside resources. External interface 720 can provide, e.g., security features and network compatibility. The external interface 720 connects the internal Policy Issuer resources to those held by, e.g., clients and/or sponsors 721a-d, service providers 723a, 723b, and clearing houses 725. Each class of external resources may utilize its own external interface, e.g., buses 722 and 724, or they may communicate directly with external interface 720. The client resources 723d may include, e.g., a database associated with the client (e.g., accounts, personal information or preferences) or a terminal used by the client to interface with the server 701. Sponsor resources 723a-723c may include, e.g., databases relating to client accounts, investment allocations, terms, and the like. The sponsors may provide data relating to client account activity.

Service providers 723a and 723b may provide resources such as transaction processing and investment research to clients and sponsors. Clearing house 725 may be used to settle transactions.

By communicating via enterprise server buses 702a and 702b, server 701 enables a managed exchange of information that allows, e.g., (1) the Policy Issuer to receive periodic account information regarding the client's sponsor account, (2) the Policy Issuer to receive its fee payments from the client's sponsor account in some implementations, (3) the client to purchase a guarantee, (4) the client to update information or preferences with the sponsor or Policy Issuer, (5) the Policy Issuer to receive timely notification of sponsor account deposits and/or withdrawals, and (6) the Policy Issuer to send written communications to the client.

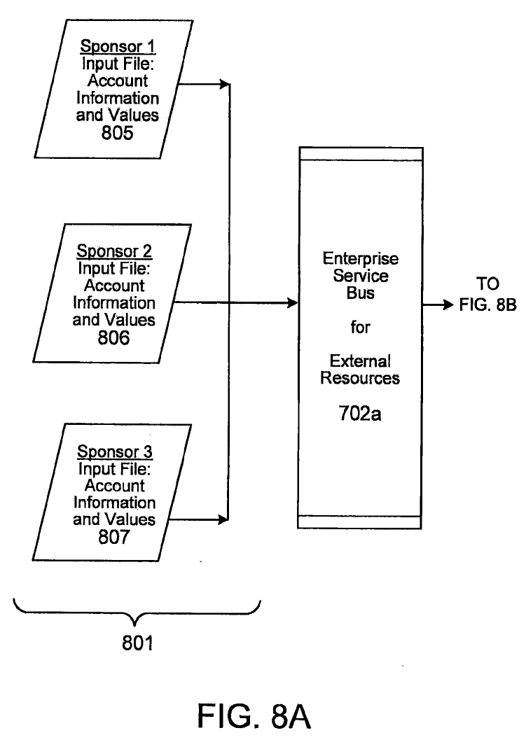

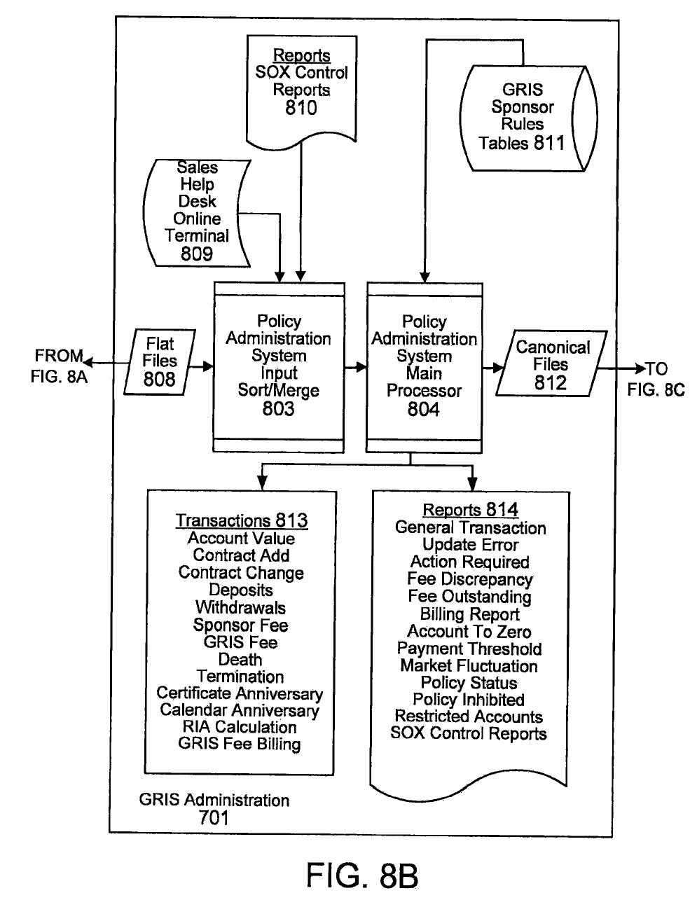

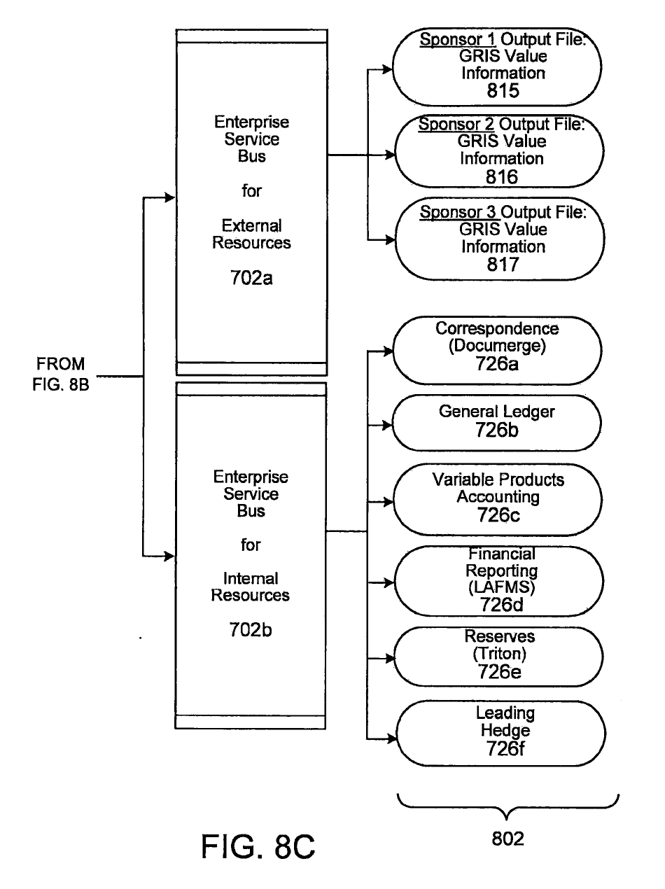

FIG. 8 illustrates schematically an exemplary flow of information from an input side 801 to an output side 802. Each sponsor (e.g., 721a-721c of FIG. 7) provides input data 805-807 to the enterprise service bus 702a. The data provided from the sponsors, via the enterprise service bus 702a, is deposited in flat files 808. Flat files are sequential data files and may enhance high-speed data processing by the server 701.

The flat files are transmitted to the Policy Administration System Sort/Merge 803 for sorting/merging of the flat data. Instruction to initiate a transaction or report may originate from the online terminal 809, and that instruction is transmitted to the sort/merge 803 for eventual execution. Also, reports (e.g., for Sarbanes-Oxley compliance) 810 inform the sort/merge 803, and may also be created based on the sort/merge 803. The sorted/merged data is then transmitted to the Policy Administration Main Processor 804. The processor 804 determines, based on the sorted data, the nature of the request and orchestrates the creation of the appropriate report 814 or execution of the appropriate transaction 813. The reports 814 and/or transactions 813 may be governed by certain rules held by the sponsors. Accordingly, rules tables 811 inform the processor 804 to ensure that transactions 813 and reports 814 are executed/created appropriately. The processor outputs canonical files 812 (i.e., hierarchical files) such as XML.

The XML 812 is transmitted to enterprise service buses 702a and/or 702b as appropriate. If the output data 812 is for an external resource, it is transmitted to enterprise service bus 702a. If the output data 812 is for an internal resource, it is transmitted to enterprise service bus 702b. In some implementations, the XML 812 includes destination data indicative of its destination, and is transmitted to both 702a and 702b. Each enterprise service bus 702 and 702b reads the destination data and routes the XML 812 appropriately. XML 812 destined for internal resources may be sent to any of the resources 726a-726f discussed in connection with FIG. 7. XML 812 destined for external resources may include data sent to a sponsor relating to a client's GRIS product 815-817.

In an alternative implementation, rather than purchasing an annuity policy, the guarantee aspect is provided to clients by purchasing exchange traded securities, e.g., those having a cash value in a first phase and a guaranteed income in a second phase.

The foregoing discussion of some implementations has included numerical values relating to, e.g., dollar values and percentages. Note that these particular numerical values were chosen simply for the purpose of illustration, and do not limit the applicability or scope of the implementations. Implementations may apply to any set of numerical values.

Various features of the system may be implemented in hardware, software, or a combination of hardware and software. For example, some features of the system may be implemented in computer programs executing on programmable computers. Each program may be implemented in a high level procedural or object-oriented programming language to communicate with a computer system or other machine. Furthermore, each such computer program may be stored on a storage medium such as read-only-memory (ROM) readable by a general or special purpose programmable computer or processor, for configuring and operating the computer to perform the functions described above.

A number of implementations have been described. Nevertheless, it will be understood that various modifications may be made without departing from the spirit and scope of the invention. Accordingly, other implementations are within the scope of the claims.

What is claimed is:

1. A method for providing a guaranteed lifetime income product to a beneficiary or to an account associated with a beneficiary comprising:
designating a first set of assets;
receiving approval from a guarantor relating to investing the assets in an asset allocation;
determining a first value of the invested assets on a first date, the first value initially equal to a monetary value of the invested assets as of the first date;
determining an income base value associated with the invested assets;
determining a second date;
periodically updating the value of the invested assets during a time period between the first date and the second date;
periodically updating the income base value based on the value of the invested assets;
determining a lifetime income percentage;
paying a lifetime annual income amount on a third date after the first value equals a predetermined minimum amount and after the second date, wherein said lifetime annual income amount equals the income base value as of the third date multiplied by the lifetime income percentage.

2. The method according to claim 1 wherein the beneficiary is an individual person.

3. The method according to claim 1 wherein the beneficiary is a married couple.

4. The method according to claim 1 wherein the assets are maintained in a sponsor account.

5. The method according to claim 4 wherein the sponsor is a bank, investment broker, investment advisor, mutual fund family, or dealer.

6. The method according to claim 1 wherein the assets comprise exchange traded funds, mutual funds, cash, stocks, fixed income securities, derivatives, private funds, money market shares, or certificates of deposit.

7. The method according to claim 1 wherein receiving approval further comprises:
providing one or more investment allocation options approved by the guarantor, each of said investment allocation options representing an approved combination of one or more investments; and
receiving a selection from the beneficiary of one or more of the investment allocation options.

8. The method according to claim 1 wherein determining a second date is performed substantially contemporaneously with designating the first set of assets.

9. The method according to claim 4 wherein periodically updating the income base value comprises:
determining additional assets deposited into the sponsor account;
increasing that income base value to reflect the deposit.

10. The method according to claim 1 wherein periodically updating the income base value comprises:
increasing the income base value to equal the value of the invested assets if the value of the invested assets is greater than the income base value.

11. The method according to claim 4 wherein periodically updating the income base value comprises:
determining if no withdrawals have been made from the sponsor account in a predetermined timeframe; and
increasing the income base value by a predetermined amount.

12. The method according to claim 1 wherein periodically updating the income base value comprises:
setting a cost of living increase amount;
increasing the income base value by the cost of living increase amount.

13. The method according to claim 12 wherein the cost of living increase amount is a percentage.

14. The method according to claim 12 wherein the cost of living increase amount is a fixed dollar amount.

15. The method according to claim 12 wherein the cost of living increase amount is based on the consumer price index.

16. The method according to claim 4 wherein periodically updating the income base value comprises:
determining a withdrawal from the sponsor account before the second date; and
decreasing the income base by the same percentage that the withdrawal decreased the value of the invested assets.

17. The method according to claim 4 wherein periodically updating the value of the invested assets comprises:
determining a withdrawal from the sponsor account after the second date;
determining that the withdrawal does not exceed a predetermined percentage multiplied by the income base value; and
updating the value of the invested assets to reflect the withdrawal.

18. The method according to claim 4 wherein periodically updating the income base value comprises:
determining a withdrawal from the sponsor account after the second date;
determining that the withdrawal exceeds a predetermined percentage multiplied by the income base value;
determining the difference between the withdrawal and the predetermined percentage multiplied by the income base value;
decreasing the income base value by the same percentage that the difference decreased the first value of the invested assets.

19. The method according to claim 1 wherein the lifetime annual income amount is paid from the guarantor to the beneficiary or an account associated with the beneficiary on a monthly basis.

20. The method according to claim 1 wherein the lifetime annual income amount is paid from the guarantor to the beneficiary or an account associated with the beneficiary on a yearly basis.

21. The method according to claim 1 wherein the lifetime annual income amount is paid from the guarantor to the beneficiary or an account associated with the beneficiary on a weekly basis.

22. The method according to claim 2 wherein the lifetime annual income amount is paid until a death of the beneficiary.

23. The method according to claim 3 wherein the lifetime annual income amount is paid until the death of the second person of the married couple.

24. The method according to claim 1 wherein the predetermined percentage is within the range of 0.25% to 25%.

25. The method according to claim 4 further comprising:
collecting a fee for providing the product; and
deducting the fee from the sponsor account or another account associated with the beneficiary.

26. The method according to claim 1 further comprising the step of collecting a fee for providing the product, the fee being a percentage of said income base value or the monetary value of the invested assets.

27. The method according to claim 1 further comprising:
setting a maximum income base value, wherein the maximum income base value cannot be exceeded regardless of the value of the invested assets.

28. The method according to claim 1 further comprising:
determining that the income base value is zero; and
terminating the product.

29. A method according to claim 1 further comprising:
terminating the product upon a death of the beneficiary.

30. A method according to claim 3 further comprising:
determining that the last living spouse has died; and
terminating the product upon a death of one person of the married couple.

31. A data processing method for administering a guaranteed retirement income product comprising:
determining a value of a retirement income base on a first date, the retirement income base having a value based on a value of assets in a third party account;
determining a retirement income percentage;
determining a retirement income date;
updating the retirement income base value based on activity in the third party account;
calculating an annual retirement income amount on the retirement income date;
periodically updating information relating to a second account with an amount equal to the annual retirement income amount if the retirement income base equals zero after the retirement income date.

32. The method according to claim 31 wherein the third party account is with a bank, investment broker, investment advisor, or dealer.

33. The method according to claim 31 wherein the third party account comprises mutual funds, cash, stocks, bonds, money market shares, or certificates of deposit.

34. The method according to claim 31 further comprising:
providing one or more approved investment allocation options, each of the investment allocation options representing an approved combination of one or more investments; and
receiving a selection of one or more investment allocation options.

35. The method according to claim 31 wherein the retirement income date is a fixed date after the first date.

36. The method according to claim 31 wherein updating the retirement income base value comprises:
determining a value of additional assets deposited into the third party account;
calculating the retirement income base value to reflect the deposit.

37. The method according to claim 31 wherein updating the retirement income base value comprises:
determining if there have been no withdrawals from the third party account in a predetermined timeframe; and
increasing the retirement income base value by a predetermined amount.

38. The method according to claim 31 wherein updating the retirement income base value comprises:
setting a cost of living increase amount;
increasing the retirement income base value by the amount.

39. The method according to claim 38 wherein the cost of living increase amount is a percentage.

40. The method according to claim 38 wherein the cost of living increase amount is a fixed dollar amount.

41. The method according to claim 38 wherein the cost of living increase amount is based on a consumer price index.

42. The method according to claim 31 wherein updating the retirement income base value comprises:
determining a withdrawal from the third party account;
determining that the retirement income date has not passed; and
decreasing the retirement income base value by the same percentage that the withdrawal decreased the third party account value.

43. The method according to claim 31 wherein updating the third party account value comprises:
determining a withdrawal from the third party account;
determining that the retirement income date has passed;
determining that the withdrawal does not exceed the retirement income percentage multiplied by the retirement income base value; and
updating the third party account value to reflect the withdrawal.

44. The method according to claim 31 wherein updating the retirement income base value comprises:
determining a withdrawal from the third party account;
determining that the retirement income date has passed;
determining that the withdrawal exceeds the retirement income percentage multiplied by the retirement income base value;
determining the difference between the withdrawal and the retirement income percentage multiplied by the retirement income base value;
decreasing the retirement income base by the same percentage that the difference decreased the third party account value.

45. The method according to claim 31 wherein updating the information relating to a second account is performed on a monthly basis.

46. The method according to claim 31 wherein updating the information relating to a second account is performed on a yearly basis.

47. The method according to claim 31 wherein updating the information relating to a second account is performed on a weekly basis.

48. The method according to claim 31 wherein the retirement income percentage is within the range of 0.25% to 25%.

49. The method according to claim 31 further comprising:
determining a fee for administering the guaranteed retirement income product; and
deducting the fee from the third party account.

50. The method according to claim 31 further comprising:
determining that the retirement income base value is zero; and
terminating the guaranteed retirement income product.

51. The method according to claim 1 comprising determining a fee for providing the guaranteed lifetime income product, wherein determining a fee comprises:
establishing a first fee percentage as of a first point in time, wherein the income base value is a first amount at the first point in time;
detecting that the income base value increased by a second amount at a second point in time;
establishing a second fee percentage on or before the second point in time;
multiplying the first fee percentage by the first amount to yield a first fee amount;
multiplying the second fee percentage by the second amount to yield a second fee amount;
adding the first fee amount to the second fee amount to yield a total fee amount; and
dividing the total fee amount by the sum of the first amount and the second amount to yield an aggregate fee percentage.

52. The method according to claim 51 comprising charging a fee for providing the guaranteed lifetime income product, wherein charging a fee comprises:
deducting the total fee amount from the value of the invested assets.

53. The method according to claim 31 comprising determining a fee for administering the guaranteed lifetime income product, wherein determining a fee comprises:
establishing a first fee percentage as of a first point in time, wherein the retirement income base is a first amount at the first point in time;
detecting that the retirement income base increased by a second amount at a second point in time;
establishing a second fee percentage on or before the second point in time;
multiplying the first fee percentage by the first amount to yield a first fee amount;
multiplying the second fee percentage by the second amount to yield a second fee amount;
adding the first fee amount to the second fee amount to yield a total fee amount; and
dividing the total fee amount by the sum of the first amount and the second amount to yield an aggregate fee percentage.

54. The method according to claim 53 further comprising charging a fee for providing the guaranteed lifetime income product, wherein charging a fee comprises:
deducting the total fee amount from the value of the third party account.

55. The method of claim 1 wherein the predetermined minimum amount is zero.

56. The method of claim 1 wherein the predetermined minimum amount is an amount less than the income base value as of the third date multiplied by the lifetime income percentage.

57. The method of claim 1 wherein the assets are maintained in a designated account, the method comprising:
collecting a fee for providing the product; and
deducting the fee from the designated account.
